(19) United States
(12) Patent Application Publication
(10) Pub. No.: US 2024/0007182 A1
(43) Pub. Date: Jan. 4, 2024

(54) METHOD AND SYSTEM OF PRODUCING A REDUNDANT OPTICAL COMB AND APPLICATIONS THEREOF

(71) Applicant: OPTIWAVE SYSTEMS INC., Ottawa (CA)

(72) Inventors: Ahmad Atieh, Ottawa (CA); Muhammad Jawad Mirza, Islamabad (PK); Salman Abdul Ghafoor, Islamabad (PK)

(21) Appl. No.: 18/337,013

(22) Filed: Jun. 18, 2023

Related U.S. Application Data
(60) Provisional application No. 63/357,263, filed on Jun. 30, 2022.

(51) Int. Cl. H04B 10/032; H04B 10/516; H04B 10/50; H04B 10/564

(52) U.S. Cl. CPC H04B 10/032; H04B 10/516; H04B 10/503; H04B 10/564

(57) ABSTRACT

The present invention describes a free spectral range (FSR) and center wavelength tunable redundant optical comb based on a sagnac loop mirror (SLM) and bidirectional Mach-Zehnder modulator (BMZM). The optical signal from a continuous wave (CW) laser is split into two parts which travel in clockwise and counter clockwise directions inside the SLM and are modulated by sinusoidal RF signal with the help of BMZM. The modulation of optical signals with sinusoidal RF signal using BMZM results into the generation of two optical combs inside the SLM. Both optical combs are obtained simultaneously at the output port of the SLM when the polarization controller (PC) is adjusted to have 90° phase difference between the clockwise and counterclockwise generated combs. The proposed design can be used in protection switching and in data centers. A corresponding method for generating redundant optical combs is also provided.

### CROSS REFERENCE TO RELATED APPLICATIONS

The present application claims the benefit from the U.S. provisional application Ser. No. 63/357,263 filed Jun. 30, 2022, the entire content of which is incorporated herein by reference.

### FIELD OF THE INVENTION

The present invention generally relates to producing optical combs, and in particular to a method and system of producing a redundant optical comb and applications thereof.

### BACKGROUND OF THE INVENTION

Over the past few years, the global demand for bandwidth and capacity has increased exponentially. This rapid increase in data traffic is typically caused by the proliferation of various bandwidth-intensive applications, such as search engines, online interactive maps, social networking, video streaming, video gaming, artificial intelligence, virtual reality/augmented reality and internet of things (IoTs). These cloud computing and web applications are compelling the data center networks (DCNs) to the “Zettabyte data level”, as foreseen by Cisco in their report. Consequently, the DCNs should have the features of high throughput, capacity, reliability, scalability, and small footprint to ensure a congestion free communication in a cost and energy efficient way. Moreover, there is a dire need for introducing high-speed data center interconnects (DCIs) capable of handling this data explosion efficiently. The DCNs need to progress towards optimum performance and throughput, while being spectral efficient and reducing the complexity and power consumption. A viable solution is to use advanced modulation with coherent detection such as quadrature amplitude modulation (QAM) or PAM-4 based intensity modulation and direct detection (IM/DD) scheme which brings the simplicity and cost efficiency. Data centers generally have multitudes of various photonic components, fiber optic cables, and optical connections enabling fast and efficient data handling among various switches, servers, and computing hardware. As the size of a data center expands, its complexity also increases resulting into high probability of various photonic components and fiber-related faults which can potentially lead to network problems or even a complete system shut down.

As the clients and enterprises become more dependent upon uninterrupted connectivity to cloud computing and web applications, therefore any kind of service interruption at DCI and component levels cannot be accepted. Therefore, the reliability of DCNs is an important and emerging design consideration which must be ensured primarily.

Modern data centers increasingly depend on optical sources and interconnects for connectivity and information transfer among numerous servers, switches, memory units, and computing devices. Majority of the commercial short reach optical interconnects (<300 m) today are based upon directly modulated vertical-cavity surface emitting lasers (VCSELs) and OM4 multimode fiber (MMF) operating at 850 nm. It has equally spaced wavelengths or sidebands which can be used as separate optical carriers for DWDM transmission. It has the capacity of eliminating the problem of energy overhead associated with separately tuning many CW lasers to maintain the required channel locking because it is generated from a single laser source and has intrinsically equidistant spacing between the spectral components. Various methods of generating optical combs have been developed over the past 20 years. These methods include generation of optical combs based on, direct modulation of CW laser with sinusoidal RF signal and electro-absorption modulator (EAM) [8], direct modulation of CW laser by sinusoidal RF signal and dual-drive Mach Zehnder modulator (DD-MZM), direct modulation of CW laser with sinusoidal RF signal and serial cascading of a phase modulator and DD-MZM, direct modulation of CW laser by sinusoidal RF signal and a single MZM, four-wave mixing (FWM) in a dispersion shifted highly nonlinear fiber (DS-HNLF), and cascaded MZMs and dispersion-flattened HNLFs (DF-HNLFs). Similarly, chip scale optical combs are reported based on FWM in an optical parametric oscillator with silicon nitride ring resonator, an integrated semiconductor laser, Kerr effect in micro resonator, and lithium niobate on insulator modulators.

Nevertheless, there is a need in the industry for developing improved or alternative methods and devices for producing optical combs.

### SUMMARY OF THE INVENTION

It is an object of the present invention to provide a method and device for generating a redundant optical comb and applications thereof.

According to one aspect of the present invention, there is provided a device for creating a redundant optical comb, comprising: a continuous wave optical signal source, an optical splitter for splitting the continuous wave optical signal into a first optical signal and a second optical signal, a sagnac loop minor for counterpropagating the first optical signal and the second optical signal, the sagnac loop minor having a bidirectional electro-optical modulator disposed therein, along a path of the first optical signal and the second optical signal, and a radio frequency (RF) source driving the bidirectional electro-optical modulator with an RF signal, for modulating the first optical signal and the second optical signal, thereby producing a first optical comb and a second optical comb, respectively, which are redundant.

In the device, the bidirectional electro-optical modulator is a bidirectional Mach-Zehnder modulator.

In the device, the continuous wave optical signal source is laser source.

In the device, wherein the optical splitter is a fused optical coupler (FOC).

The device further comprises a polarization controller (PC), to automatically control a power of the first optical comb and a power of the second optical comb at an output of the sagnac loop minor.

In the device, the bidirectional electro-optical modulator comprises a bias voltage controller for controlling a range of the bias voltage resulting in a pre-determined flatness of intensity peaks of the redundant optical comb.

According to another aspect of the present invention, there is provided a method for producing a redundant optical comb, comprising: generating a continuous wave optical signal, splitting the continuous wave optical signal into a first optical signal and a second optical signal, counterpropagating the first optical signal and the second optical signal in a sagnac loop mirror having a bidirectional electro-optical modulator disposed therein, along a path of the first optical signal and the second optical signal, and driving the bidirectional electro-optical modulator with a radio frequency (RF) signal from a RF source, resulting in modulation of the first optical signal and the second optical signal, thereby producing a first optical comb and a second optical comb, respectively, which are redundant.

Thus, an improved method and device for generating a redundant optical comb have been provided.

### BRIEF DESCRIPTION OF THE DRAWINGS

Embodiments of the present invention will be further described with reference to the accompanying exemplary drawings, in which:

FIG. 1 illustrates a device for generating redundant optical combs of the embodiment of the invention based on SLM containing a BMZM;

FIG. 2A shows a spectral plot of a primary optical comb obtained at the output of SLM;

FIG. 2B shows the spectral plot of a secondary optical comb obtained at the output of SLM;

FIG. 3A shows the influence of bias drift on flatness of the primary and secondary combs;

FIG. 3B shows the influence of bias drift on the unwanted-mode suppression ratio (UMSR) of the primary and secondary combs;

FIG. 4 shows the linewidths of the comb lines of the primary and the secondary combs; and

FIG. 5 illustrates a method generating redundant optical combs.

### DETAILED DESCRIPTION OF THE EMBODIMENTS

The Redundant Optical Comb

The embodiments of the present invention describe method and system for creating a primary optical comb, also to be referred to as a first optical comb, and a secondary optical comb, also to be referred to as a second optical comb, any of the above noted optical combs individually to be also referred to as a redundant optical comb, or together to be referred to as redundant optical combs.

The redundant optical combs are produced using a sagnac loop mirror (SLM) and bidirectional Mach-Zehnder modulator (BMZM) whose free spectral range (FSR) and central wavelength may be tuned by varying the frequency of sinusoidal radio frequency (RF) signal. The light emitted from a continuous wave (CW) laser centered at 1300 nm is split into two parts, a first optical signal and a second optical signal, that propagate inside the SLM in opposite directions. The modulation of both optical signals travelling in opposite directions with sinusoidal RF signal generates two optical combs, the first optical comb 1010, or the primary optical comb, and the second optical comb 1020, or the secondary optical comb. A combination of a polarization controller (PC) is used to perform automatic control of the presence of the combs at the output ports of the sagnac loop mirror.

The control of the PC is driven by an external electrical signal generated by other monitoring equipment used to oversee the health of the communication system. Optical combs of 67 stable comb lines with FSR of 0.1 nm and 0.05 nm are successfully generated having linewidth and UMSR of nm and 47 dB, respectively. The redundant optical combs of the present invention were designed using OptiSystem 19 commercial software tool.

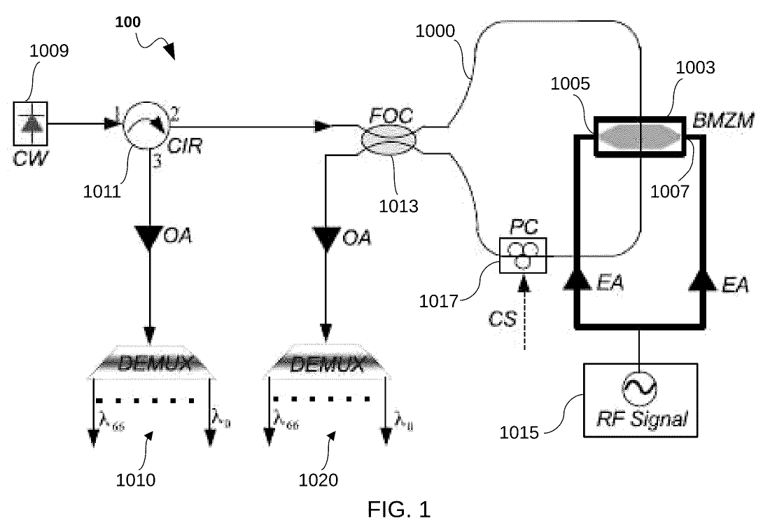

FIG. 1 illustrates a device 100 for producing redundant optical combs of the embodiment of the present invention. The device comprises a sagnac loop mirror (SLM) 1000, and a BMZM 1003 located approximately at the center of the SLM and has dual input RF ports 1005 and 1007. An optical signal, or a continuous wave (CW) optical signal, with power of 0 dBm centered at 1300 nm is created by a CW laser 1009 passed through a circulator 1011 and split into two parts using 50:50 fused optical coupler (FOC) 1013, or optical splitter. One part of the optical signal, a first optical signal, travels in the clockwise direction, and the other, a second optical signal, travels in counter clockwise direction inside the SLM 1000. The BMZM 1003 is driven by a sinusoidal RF signal of 12.5 GHz, from an RF source 1015, which is applied to its input RF ports 1005 and 1007. The BMZM 1003 has the same frequency response when it operates in both directions as long as the sinusoidal RF signal is travelling in the same direction as the optical signal inside the BMZM 1003. Both optical signals inside the SLM 1000, the first optical signal and the second optical signal, are modulated by the sinusoidal RF signal generated by an RF source 1015. Electro-optic modulation of light in the BMZM 1003, which varies the refractive index in the arms of the modulator, is used to create the first optical comb 1010 and the second optical comb 1020 respectively. The applied sinusoidal electrical voltage to the terminals of the BMZM 1003 causes a change in the refractive index in each arm of the BMZM 1003, resulting in phase difference between the arms, thus affecting the constructive and destructive interference of the light passing in each arm depending on the amplitude of the applied sine wave. Multiple side-bands with even spectral spacing on both sides of the fundamental light frequency component are generated. The spectral spacing between the side bands is related to the applied sinusoidal frequency. The number of the side band components depends on its amplitude. It is understood that the BMZM 1003 may also operate in a chirp mode.

The electrical drive signals are applied to both RF ports 1005 and 1007 of the BMZM 1003 and adjusted in such a way to improve the chirping to obtain the desired number of comb lines with uniform OSNR. The phase of the optical signals modulates after passing through the BMZM 1003.

The modulated optical signals emerge at the output ports of BMZM 1003 as two identical optical combs 1010 and 1020 that continue propagating inside the SLM 1000 to the FOC 1013 terminals.

An automatic control of the presence of the optical comb 1010 and 1020 at the output of the SLM is achieved by controlling the setting of the polarization controller (PC) 1017 to adjust the phase difference between the first and second generated combs 1010 and 1020 inside the SLM 1000.

Only one optical comb 1010 appears at port 3 of the circulator 1011 when the phase difference between the first and second optical combs 1010 and 1020 is 0°, which is a reflection operation mode of the SLM 1000. However, when the phase difference between the first and second optical combs 1010 and 1020 is 180°, the second optical comb 1020 appears at the output port of the FOC 1013, which is a transmission operation mode of the SLM 1000.

The switching feature between the output port of the FOC 1013 and the output port 3 of the circulator 1011 finds a useful application in protection switching where a control signal (CS) is used to control the phase difference created between the first and second optical combs 1010 and 1020 inside the SLM 1000 set by the PC 1017. First and second optical combs 1010 and 1020 with equal power levels can be obtained at both ports of the circulator 1011 and the FOC 1013 when the phase difference between the first and second optical combs 1010 and 1020 is set to 90°. The automatic control of the presence of the optical combs 1010 and 1020 at the output of the SLM is elaborated by the following two scenarios.

Case 1

In a normal operating condition, the CS is at logic “HIGH” indicating no fault is detected and no power drop in the received optical power below a set threshold. Therefore, the CS keeps the phase of the PC 1017 inside the SLM 1000 at 0°. Consequently, the primary optical comb 1010, or first optical comb, is presented at port 3 of the circulator 1011. Typically, the primary comb 1010 is modulated and transmitted over a primary optical fiber.

Case 2

When either a break occurs in the primary fiber, a power level at a receiver drops below a certain threshold, or the receiver metrics deteriorate below set thresholds, the CS logic becomes “LOW”. As a result, the setting of the PC 1017 inside the SLM 1000 is adjusted to create a phase difference between the first and second optical combs equal to 180°. Consequently, the secondary optical comb 1020, or the second optical comb, is present at the output of SLM 1000 and available at the output port of the FOC 1013. The second optical comb 1020 is then modulated and transmitted instead the first optical comb 1010 over a secondary optical fiber. In order to simulate the special case of redundant optical combs 1010 and 1020 in OptiSystem software tool, the phase of the PC 1017 is set manually. Both optical combs 1010 and 1020 could appear simultaneously at the output of the SLM 1000 as a special case of the design when the phase difference between the redundant combs is 90°.

Table I below lists the main simulation parameters used in the simulation experiments.

TABLE I
SIMULATION PARAMETERS

| Sr. No | Parameters | Values | |
|---|---|---|---|
| 1 | Wavelength of CW laser | 1300 | nm |
| 2 | Frequency of Sinusoidal RF signal | 12.5 | GHz |
| 3 | Extinction ratio of BMZM | 30 | dB |
| 4 | Gain of OAs | 20 | dB |
| 5 | Noise figure of OAs | 4 | dB |
| 6 | Gain of EAs | 10 | dB |
| 7 | Resolution bandwidth | 0.1 | nm |

Results and Discussions

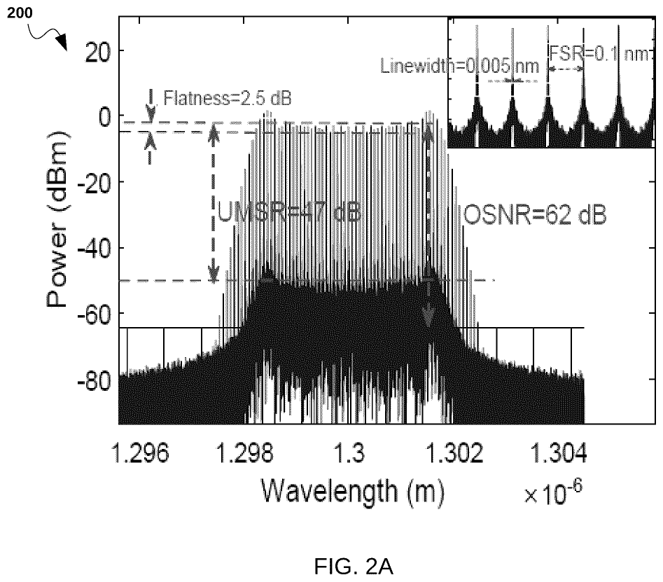

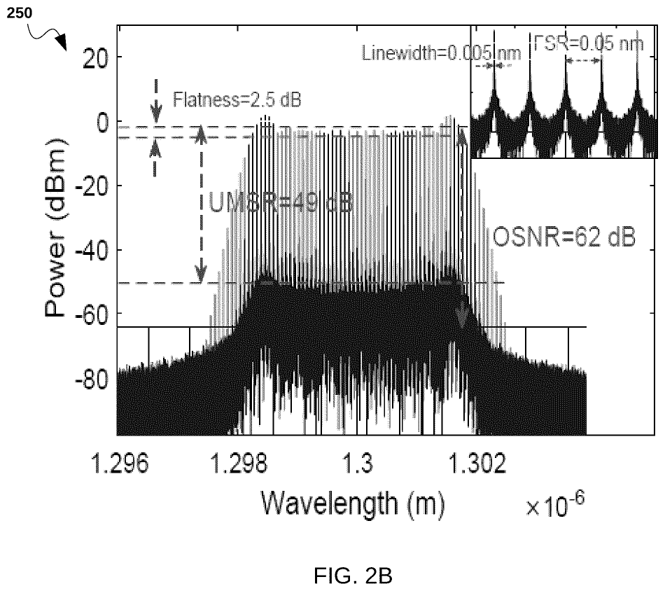

FIG. 2A and FIG. 2B show respective spectral plots 200 and 250 of primary and secondary optical combs 1010 and 1020 obtained at respective outputs of the SLM 1000. It may be observed from plots 200 and 250 in FIGS. 2A and 2B, respectively, that both primary and secondary optical combs 1010 and 1020 have 67 stable comb lines and unwanted-mode suppression ratios (UMSRs) of 47 dB and 49 dB, respectively. Similarly, both combs have OSNR and flatness of about 62 dB and about 2.5 dB, respectively. Moreover, the linewidth of the primary and secondary comb lines is around 0.005 nm as shown in the inserts on FIGS. 2A and 2B, respectively. The FSR of the primary and secondary optical combs 1010 and 1020 is tuned by varying the frequency of the applied sinusoidal RF signal 1015 to the BMZM 1003. The FSR of the primary optical comb 1010 selected at the output of the SLM is about 0.1 nm as shown in the insert on FIG. 2A, when the BMZM 1003 is driven by a 12.5 GHz signal. The FSR of the secondary optical comb 1020 selected at the output of the SLM 1000 is about 0.05 nm as shown in the insert on FIG. 2B, when the BMZM 1003 is driven by a 6.25 GHz signal.

The bias drift has a deteriorating effect on the performance of the optical combs 1010 and 1020. Therefore, we vary the bias voltage of the BMZM in a range from about −2 V to about 2 V in the simulation to check the performance of the device 100.

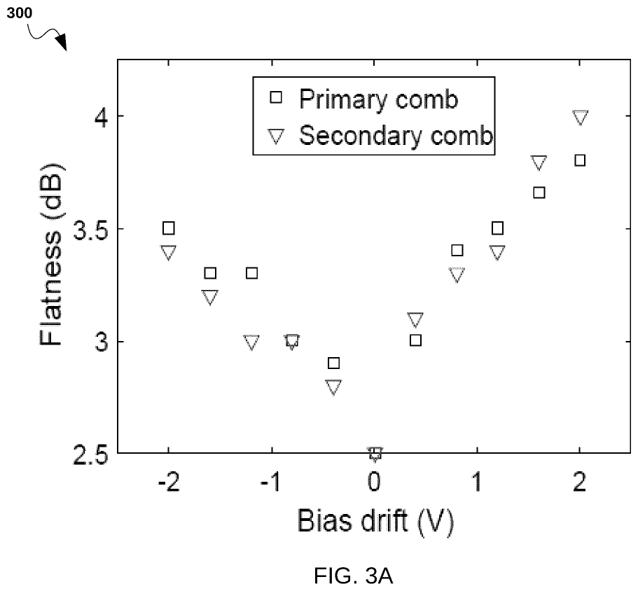

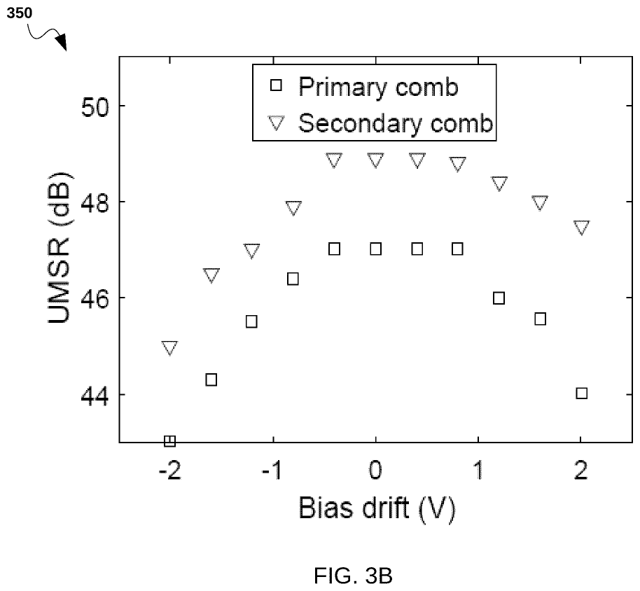

FIG. 3A and FIG. 3B show respective plots 300 and 350 illustrating the influence of the bias drift on flatness and UMSR, respectively, of the primary and secondary combs 1010 and 1020. It may be observed from the plot 300 of FIG. 3A that there is a variation of around 1 dB in flatness of the primary and secondary combs 1010 and 1020 corresponding to the bias drift between−2 V and 2 V.

Similarly, it may be seen from the plot 350 in FIG. 3B that there is a variation of around 4 dB in the UMSR of the primary and secondary combs 1010 and 1020 corresponding to the bias drift between−2 V and 2 V.

An operational range of the bias drift (bias voltage applied to the BMZM 1003) may be chosen so that a predetermined intensity flatness (or dB flatness) of the primary and secondary combs is achieved, namely, an intensity variation between comb lines (individual peaks) is within a predetermined intensity range.

Similarly, an operational range of the bias drift (bias voltage applied to the BMZM 1003) may be chosen so that a predetermined UMSR flatness of the primary and secondary combs is achieved, namely, a UMSR variation is within a predetermined UMSR range.

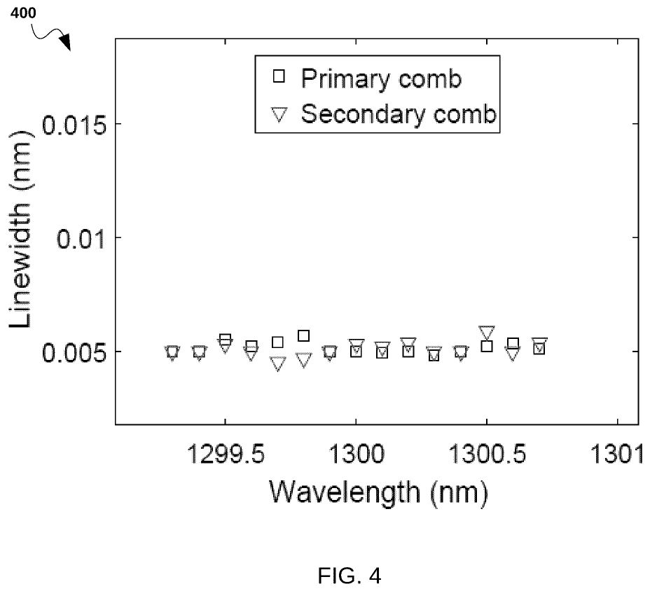

In order to investigate the variation in linewidth of comb lines of the primary and secondary combs 1010 and 1020, we plot the linewidth of the comb lines versus wavelength by randomly selecting 12 comb lines of primary and secondary combs 1010 and 1020. FIG. 4 shows plot 400, illustrating that the linewidth of all comb lines is around 0.005 nm. Thus, there is a negligible variation in linewidth of comb lines of primary and secondary combs 1010 and 1020.

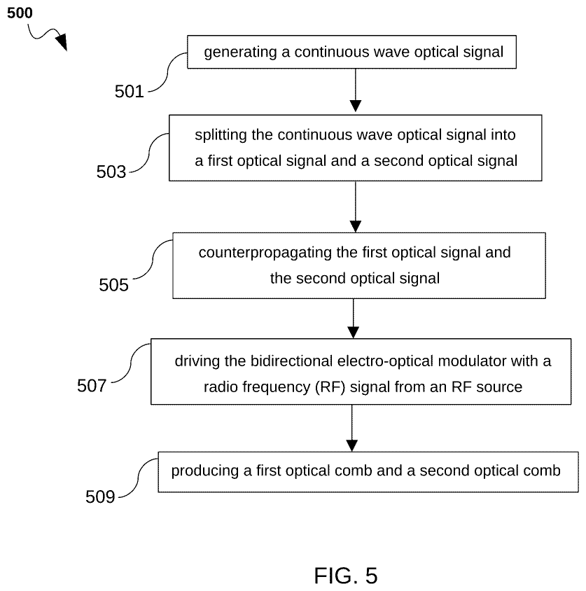

FIG. 5 shows a flow chart 500 illustrating a method for producing a redundant optical comb, including the steps of generating a continuous wave optical signal (box 501), splitting the continuous wave optical signal into a first optical signal and a second optical signal (box 503), counterpropagating the first optical signal and the second optical signal in a sagnac loop mirror (box 505), the sagnac loop mirror having a bidirectional electro-optical modulator disposed therein, along a path of the first optical signal and the second optical signal, and driving the bidirectional electro-optical modulator with a radio frequency (RF) signal from an RF source (box 507), comprising operating the bidirectional electro-optical modulator, resulting in modulation of the first optical signal and the second optical signal, thereby producing a first optical comb and a second optical comb, respectively (box 509), which are redundant.

### Conclusion

Thus, the device and method for producing redundant optical combs 1010 and 1020 of the embodiment of the present invention, using a sagnac loop minor 1000 and bidirectional Mach Zehnder modulator 1003, have been described.

It should be noted that methods and systems of the embodiments of the invention and data sets described above are not, in any sense, abstract or intangible.

It is understood that instead of bidirectional Mach Zehnder modulator, another bidirectional optical modulator may be used, for example the BMZM may be replaced with any alternative modulation scheme that supports bidirectional modulation and can be used for comb generation.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

### REFERENCES

[1] S. T. Ahmad, P. D. Lakshmijayasimha, A. K-Anandarajah, C. Browning, and P. M. Anandarajah, “Active demultiplexer-enabled directly modulated DMT transmission using optical frequency combs for data center interconnects,” Journal of Lightwave Technology, vol. 39, no. 17, pp. 5468-5473, 2021.
[2] J. Mirza, A. Raza, A. Atieh, S. Iqbal, and S. Ghafoor, “Self restorable intra data center interconnect based on multimode fiber and free-space optics,” Optical Engineering, vol. 60, no. 3, pp. 036113-10, 2021.
[3] Cisco Visual Networking, “The Zetabyte Era-Trends and Analysis,” Cisco white paper, 2017.
[4] M. M-Osman, and D. V. Plant, “A comparative study of technology options for next generation intra-and inter-datacenter interconnects,” In Optical Fiber Communications Conference and Exposition (OFC), pp. 1-3, 2018.
[5] J. Meza, T. Xu, K. Veeraraghavan, and O. Mutlu, “A large scale study of data center network reliability,” In Proceedings of the Internet Measurement Conference, pp. 393-407, 2018.
[6] S. Iqbal, M. Iqbal, A. Raza, J. Mirza, S. Ghafoor, M. El-Hajjar, and M. F. U. Butt, “Linearly polarised modes enabled PAM-4 data transmission over few-mode fibre for data centre interconnect,” Electronics Letters, vol. 56, no. 21, pp. 1125-1127, 2020.
[7] Q. Cheng, M. Bahadori, M. Glick, S. Rumley, and K. Bergman, “Recent advances in optical technologies for data centers: a review,” Optica, vol. 5, no. 11, pp. 1354-1370, 2018.
[8] S. Iezekiel, “Measurement of microwave behavior in optical links,” IEEE microwave magazine, vol. 9, no. 3, pp. 100-120, 2008.
[9] J. K. Hmood, S. D. Emami, K. A. Noordin, H. Ahmad, S. W. Harun, and H. M. H Shalaby, “Optical frequency comb generation based on chirping of Mach—Zehnder Modulators,” Optics Communications, vol. 344, pp. 139-146, 2015.
[10] S. Ullah, R. Ullah, Q. Zhang, H. A. Khalid, K. A. Memon, A. Khan, F. Tian, and X. Xiangjun, “Ultra-wide and flattened optical frequency comb generation based on cascaded phase modulator and LiNbO3-MZM offering terahertz bandwidth,” IEEE Access, vol. 8, pp. 76692-76699, 2020.
[11] J. Mirza, S. Ghafoor, and A. Hussain, “All-optical generation and transmission of multiple ultrawideband signals over free space optical link,” Optical Engineering, vol. 58, no. 5, pp. 056103-, 2019.
[12] T. Mehmood, and S. Ghafoor, “Millimeter-wave signal generation and transmission to multiple radio access units by employing nonlinearity of the optical link,” International Journal of Communication Systems, vol. 32, no. 1, pp. 1-11, 2019.
[13] S. Yu, F. Bao, and H. Hu, “Broadband optical frequency comb generation with flexible frequency spacing and center wavelength,” IEEE Photonics Journal, vol. 10, no. 2, pp. 1-7, 2018.
[14] L. Jacob S, A. Gondarenko, M. A. Foster, A. C. Turner-Foster, A. L. Gaeta, and M. Lipson,“CMOS-compatible multiple-wavelength oscillator for on-chip optical interconnects,” Nature Photonics, vol. 4, no. 1, pp. 37-40, 2010.
[15] B. Stern, X. Ji, Y. Okawachi, A. L. Gaeta, and M. Lipson, “Fully integrated chip platform for electrically pumped frequency comb generation,” In CLEO: Science and Innovations, pp. SM1D-6, Optical Society of America, 2018.
[16] X. Xue, P-H. Wang, Y Xuan, M. Qi, and A. M. Weiner, “High-efficiency WDM sources based on microresonator Kerr frequency combs.” In Optical Fiber Communication Conference, pp. M3F-2, Optical Society of America, 2017.
[17] M. Xu, M. He, Y. Zhu, S. Yu, and X. Cai, “Flat optical frequency comb generator based on integrated lithium niobate modulators,” Journal of Lightwave Technology, vol. 40, no. 2, pp. 339-345, 2022.
[18] F. Koyama, and K. Iga, “Frequency chirping in external modulators,” Journal of Lightwave Technology, vol. 6, no. 1, pp. 87-93, 1988.
[19] J. Mirza, B. Kanwal, W. A. Imtiaz, and A. Atieh, “Single mode fiber free space optic based hybrid 32 2 Gbps WDM-PON architecture employing optical frequency comb source and polarization multiplexing,” Optical Review, vol. 28, no. 2, pp. 255-265, 2021.
[20] S. Arahira, S. Oshiba, Y. Matsui, T. Kunii, and Y. Ogawa, Opt. Lett. 19, 834 (1994).
[21] M. Nakazawa, E. Yoshida, and K. Tamura, Electron. Lett. 33, 1318 (1997).

1. A device for creating a redundant optical comb, comprising:
a continuous wave optical signal source;
an optical splitter for splitting the continuous wave optical signal into a first optical signal and a second optical signal;
a sagnac loop minor for counterpropagating the first optical signal and the second optical signal, the sagnac loop mirror having a bidirectional electro-optical modulator disposed therein, along a path of the first optical signal and the second optical signal; and
a radio frequency (RF) source driving the bidirectional electro-optical modulator with an RF signal, the bidirectional electro-optical modulator operating, for modulating the first optical signal and the second optical signal, thereby producing a first optical comb and a second optical comb, respectively, which are redundant.

2. The device of claim 1, wherein the bidirectional electro-optical modulator is a bidirectional Mach-Zehnder modulator.

3. The device of claim 1, wherein the continuous wave optical signal source is laser source.

4. The device of claim 1, wherein the optical splitter is a fused optical coupler (FOC).

5. The device of claim 1 further comprising a polarization controller (PC), to automatically control a power of the first optical comb and a power of the second optical comb at an output of the sagnac loop minor.

6. The device of claim 1, wherein the bidirectional electro-optical modulator comprises a bias voltage controller for controlling a range of a bias voltage change to achieve a predetermined flatness of intensity of individual comb peaks in the redundant optical comb.

7. A method for producing a redundant optical comb, comprising:
generating a continuous wave optical signal;
splitting the continuous wave optical signal into a first optical signal and a second optical signal;
counterpropagating the first optical signal and the second optical signal in a sagnac loop minor having a bidirectional electro-optical modulator disposed therein, along a path of the first optical signal and the second optical signal; and
driving the bidirectional electro-optical modulator with a radio frequency (RF) signal from a RF source, comprising operating the bidirectional electro-optical modulator, resulting in modulation of the first optical signal and the second optical signal, thereby producing a first optical comb and a second optical comb, respectively, which are redundant.
